(19) United States
(12) Patent Application Publication
(10) Pub. No.: US 2002/0160348 A1
(43) Pub. Date: Oct. 31, 2002

(54) Method for automation of dynamic test item collection and assessment

(75) Inventors: Ying-Dar Lin, Hsinchu (TW); Tsung-Shun Wu, Hsinchu (TW); Huan-Yun Wei, Hsinchu (TW); Chien Chou, Hsinchu (TW)

Correspondence Address: BACON & THOMAS, PLLC, 625 SLATERS LANE, FOURTH FLOOR, ALEXANDRIA, VA, 22314

(73) Assignee: National Science Council of Republic of China

(21) Appl. No.: 10/108,505

(22) Filed: Mar. 29, 2002

Related U.S. Application Data
(63) Continuation-in-part of application No. 09/520,951, filed on Mar. 8, 2000, now abandoned.

(51) Int. Cl. G09B 7/00

(52) U.S. Cl. 434/322

(57) ABSTRACT

Keywords: computer assisted test, test assessment, test collection, distant learning. The main problem with the network test base system is that there are neither sufficiently many nor good enough test items. To satisfy these two points, there must be more test item resources and a mechanism for assessing test items to determine whether a test item should stay in the test base. The present invention provides a method for automation of dynamic test item collection and assessment, which allows teacher and students to contribute test items to the test base and each independently managed test base can share test items. This can make the test base rapidly grow and expand the size of a test base. The more independent the student are, the higher the applicability of this method is. For assessing the quality of a test item, the present invention modifies a conventional internal consistency analysis, which can immediately change the discriminations of the test items once a student finishes the test, but does not need to wait until all students finish the test like all traditional assessment analysis. This method is called the dynamic weighted internal consistency analysis.

### BACKGROUND OF THE INVENTION

1. Field of the Invention

This invention relates to a method for automation of dynamic test item collection and assessment and, more particularly, to a method for automation of dynamic test item collection and assessment.

2. Description of the Prior Art

Along with the development of the computer network, we can easily obtain information and messages from a distant partner and share each other's resources. For example, we can obtain course material from a distant web site through the network. This makes distant learning one way of education or training.

So is the learning evaluation. In contrast to traditional schedules on-site tests, there are also computer assisted testing systems on the network. They do not only grant the examinees a greater flexibility, but also allow the instructors to quickly and accurately make a decision on the test results through the graphical analysis so as to increase the teaching quality.

The software on the market can be classified into the following two categories:

1. Packages [1]:

The whole software package is stored in a disk (or CD-ROM). Aside from the test base provided by the manufacturer, all rest test items have to be input by the user(s). Since the test base can only built on a single PC, but not through the network, the increasing speed of the test base is limited. Moreover, the editing of the test is purely manual.

2. Network tests, which can be classified into four classes:

a) For classes [2]:

It already has the online test function, but the test base has to be built by the teacher along. It also has the function of randomly selecting test items.

b) For network cram schools [3]:

It has the online test function, randomly selects test items by the computer. The test base is built by the manufacturer only.

c) For test service web sites [4]:

This is similar to the previous one, nevertheless, the teacher can make up test items and there are reports and analysis on tests. There is no test item assessment function. Of course, students can not make up test items.

d) For standard test institutes [5]:

Widely recognized test systems with authorities, such as computerized tests TOEFL, GRE, GMAT, etc, have a specific goal and orientation and are not flexible.

Thus they are not popular in usual education units, such as schools and cram schools. Although the above server has equipped with basic functions, yet the derived test items are: How to quickly expand the test base and increase its quality? Namely, how to effectively increase the content of the test base under finite time and human resources for an institute (assuming a high school) with such a test base server since the quality and quantity of the test items in the test base affect the implementing effects of these systems? And how to determine the test items are qualified for tests once there are enough test items in the test base?

For these two concerns, we increased in the already designed and completed DIYExamer system [6] some breakthrough functions, namely, do it yourself (DIY), test item assessment, and test base sharing.

We used various keyword combinatorics to look up patents of conventional methods for test item collection and assessment, the result is shown in the appended document.

There are one entry for the keywords “computer assisted testing”, four entries for the keywords “education AND internal consistency”, sixteen entries for the keywords “test acquisition”, one entry for the keywords “test evaluation AND internal consistency”, and two entries for the keywords “education AND test evaluation”. In particular, only the U.S. Pat. No. 4,787,036 seems relevant from the title, however, it is irrelevant to the present invention as one can learn from its abstract.

Therefore, the conventional methods are imperfect designs and still have many defects that need to be improved. In view of the foregoing disadvantages derived from conventional methods, the inventor then made efforts to improve and modify and, after many years of research and hard working, finally came up with the method for automation of dynamic test item collection and assessment.

### SUMMARY OF THE INVENTION

The present invention provides a method for automation of dynamic test item collection and assessment, which has the features that:

1. DIY:

As we know that “Rome was not built in a day”, it is not built by one person either. A hard task would not be difficult any more if it can be done by many people. Similarly, in addition to teachers, if all students can contribute test items without limitation in time and places, then the test base can grow at a tremendous speed.

2. Test base sharing:

Several servers managed by different institutes can share their test items. This multi-server structure similar to the distributive system does not speed up the speed of test item collection, but also facilitates communication and comparison among different test groups. For example, suppose two junior senior high schools share their test bases, then teachers can compare their test item styles and difficulty and students can benefit from this so as to be exposed to various test items. This method can thus enhance the test effect and the objectivity of the test base. This kind of advantages is indeed invaluable.

3. Test item assessment:

To have the function of DIY, test item assessment is an indispensable function. There are two kinds of test bases in DIYExamer, namely, the main test base and the temp test base. The former is the qualified test base, while the later is the test base that contains DIY test items to be assessed. (Test items designed by teachers can be put in either the main or the temp test base optionally.) For a test profile, the teacher can choose the ratio of number of test items from the main and the temp test bases so as to assess test items in both test bases. The DIYExamer server would perform calculations on the difficulty assessment of the test items in each randomly generated test. Through certain test filtering, the test items in the temp test base can be upgraded to the main test base. On the other hand, the test items in the main test base are not necessarily the best and can be improper after a period of time. Through the assessment procedure, test items in the main test base can be downgraded to the temp test base or even deleted from the system.

The method for automation of dynamic test item collection and assessment with the above advantages can operate independently and provides the user with the test function. If one wants to expand test items, he or she can join a test union and share the resources in the test union. The DIYExamer server mainly supports three functions; they are test item design, test item assessment, and test. Each DIYExamer server can cooperate with other DIYExamer servers through a test base sharing layer (TSL) via the network. TSL is between the user interactive layer and the database and provides the following functions: (1) processing input data; (2) interacting with a local database; (3) selecting test items from the test base. Finally, the method achieves the ultimate goal through an algorithm for assessing test item difficulty.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The drawings disclose an illustrative embodiment of the present invention which serves to exemplify the various advantages and objects hereof, and are as follows:

FIG. 1 is a system structure of the method for automation of dynamic test item collection and assessment according to the present invention; and

FIG. 2 is a comparison of samples taken in the traditional method and DIYexamer method.

### DETAILED DESCRIPTION OF THE PREFERRED EMBODIMENT

The following gives an explanation about terms used in the embodiment:

1. Test item: each independent test item in the test base is a test item, any one that has a specific solution so that the system can automatically determine whether the answer is correct can be a test item. The current system supports choice test items.

2. Test base: all the test items in the same subject form a test base.

3. Test profile: the test profile is used to define the test format and content.

The DIYExamer system automatically generate a test with items conforming with the settings, such as the number of test items, test time, difficulty, distinguishing ability, subject and section, defined in the test profile.

4. Test: a test is generated from the test profile.

5. Test union: several DIYExamer servers form a network distributive test base system, each DIYExamer server can share with other servers all the test items in the test base.

System Structure

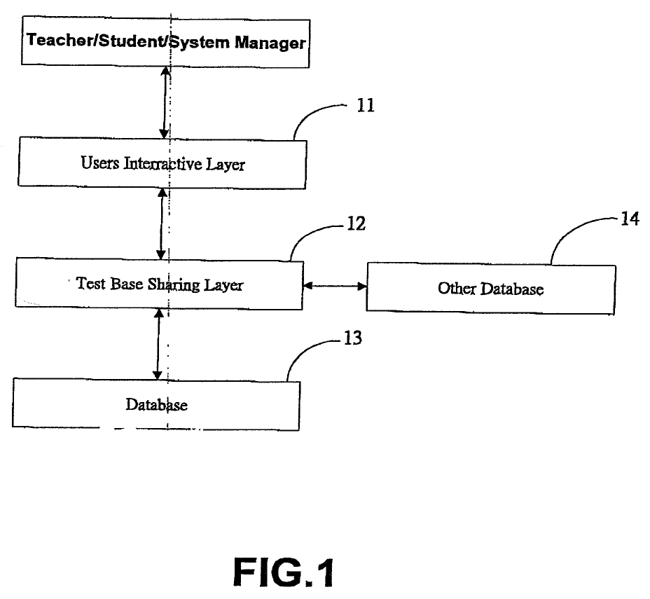

Please refer to FIG. 1, which is a system structure of the method for automation of dynamic test item collection and assessment according to the present invention. According to the drawing, the DIYExamer server of the present invention can operate independently and provides the user with the test function. If one wants to expand test items, he or she can join a test union and share the resources in the test union. The DIYExamer server mainly supports three functions, they are test item design, test item assessment, and test.

Each DIYExamer server can cooperate with other DIYExamer servers through a test base sharing layer (TSL) 12 via the network. TSL 12 is between the user interactive layer 11 and the database 13 and provides the following functions:

(1) Processing input data:

Data of all users can be input through the interactive layer. That is, the form constructed on a browser and a common gateway interface (CGI) can receive all sorts of input data from the user.

(2) Interacting with a local database:

Data such as the user account, test items, test record, etc, can be added to or eliminated from the database 13

(3) selecting test items from the test base:

If the DIYExamer server joins the test union, then test items in the test base 14 of a distant DIYExamer server can be retrieved for generating a test. It can also obtain test items in a random order from other servers.

Assessment Method

The main purpose of the assessment is to determine the effect of a test item in distinguishing students' levels. A good test item, i.e., a test item with a higher distinguishing ability, is the one that can be correctly answered by a good student and the one that an ill-prepared student fails upon. Only this kind of test items can distinguish the students and make the test more meaningful. This method is further explained in four aspects:

1. Naive thought

When analyzing test items, the discrimination of the test item correctly (incorrectly) answered by a student with a better academic record should be raised (lowered); while at the same time, the discrimination of the test item correctly (incorrectly) answered by a student with a worse academic record should be lowered (raised). Therefore, in the calculation of this analysis, it is the main point to focus on the percentage of test items that are correctly and incorrectly answered, respectively. That is, there are percentages of correctly and incorrectly answered test items for each student in each test. If the student is correct on a test item, then the percentage of correctness of the student is added to the original total discrimination number of this test item (the total discrimination number is the sum of the discrimination for this test item on every student, and the total discrimination number divided by the number of persons who did this test item is the discrimination). Then the number of persons who did this test item is added by one, and the current discrimination of this test item is the quotient of the total discrimination number divided by the number of persons who have done this test item. On the other hand, if the student fails on this test item, then the percentage of incorrectness of the student is added to the original total discrimination number of this test item, the number of persons who did this test item is added by one, and the total discrimination number divided by the number of persons who have done this test item is the current discrimination of this test item.

2. Reason

From such calculation, one can see that: since a student with a better academic record has a high percentage in correctly answering test items, if he or she correctly answers some test item the discrimination of the test item would be positively influenced by his or her percentage number. The more students with better academic records correctly answer this test item, the higher the discrimination is raised. On the other hand, since a student with a worse academic record has a high percentage in incorrectly answering test items, if he or she correctly answers the test item the averaged discrimination of the test item would be lowered by his or her percentage number. From the viewpoint of incorrect answers, since a student with a better academic record is less likely to answer incorrectly, if he or she fails on a test item the discrimination would be lowered. Similarly, since a student with a worse academic record has a higher percentage in making incorrect answers, if he or she fails on the test item the discrimination of this test item would be increased. Accumulating the total discrimination number from students that have done this test item through this method and dividing it by the number of students, one then gets the averaged discrimination.

3. Corrected thought

However, if all students who have taken the test are taken into account, then averaged students have medium correction to the discrimination whether they are right or wrong on the test item. This would lower the discrimination for a good test item but raise that for a bad one, and bring the discriminations of all test items closer so that the function of discriminating test items is lowered. Therefore, when computing item discriminability, only those students with relatively high and relatively low scores are taken as samples.

In the traditional discriminability assessment method [7], including the U. S. Pat. No. 5,954,516 [8], those in the top 27% and the bottom 27% rank groups are chosen as samples. The top 27% scorers are defined as “high-rank group (H)”, while the bottom 27% scorers are defined as “low-rank group (L)”. However, it is possible that these scores differ only slightly from the average score especially when scores are not wide-spread distributed, where many scorers should not be considered in computing the discriminability.

When selecting sample students, therefore, only those whose scores have large gap with the average score should be considered. Accordingly, those with the top 27% [9], in terms of range, scores are defined as “high-score group (H′)”, while those with the bottom 27% scores are defined as “low-score group (L′)”. This method divides the score difference between the highest score and the lowest score to date into 100 parts and the score difference is measured as 100% of difference. The students with scores ranging from 73% to 100% and from 0% to 27% are included for discrimination calculation.

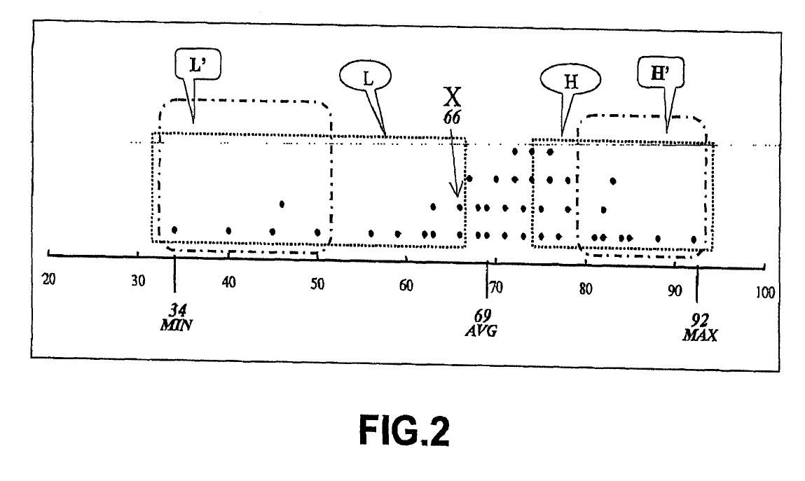

To show the different criteria and effects of choosing samples in the traditional method and DIYexamer method, FIG. 2 depicts the score distribution in a test. In this example, the highest score is 92, the lowest score is 34, and the average score is 69. The “high rank score group” and the “low rank score group” are chosen according to these two methods. Take student X as an example, the score of X is 66, which differs only 3 points from the average score. The associated information of X should have little, if not none, referential value in computing item discriminability. However, X is chosen as a sample in the high rank group in the traditional method. This fallacy results from using rank group, in terms of count, as the criterion of choosing samples. In DIYexamer, X is not chosen since score group, in terms of range, rather than rank group is used. Only those with large gap with the average score are chosen as samples.

4. Method for determining discrimination

Suppose for a test item, Accumulator is the total discrimination number and n-l students have worked on it. Now the nth student works on this test item. Then the method for determining the discrimination of the test item comprises the following steps:

verify if the score of the student is above the high threshold for ratio of correct answer (ranging from 73% to 100% in scores) or below the low threshold for ratio of correct answer (ranging from 0% to 27% in scores). If it does, then the score is influential in determining the discrimination of the test item;

if the score is higher (lower) than the highest (lowest) score among the past test takers, recalculate the new highest (lowest) score, and then the new high (low) threshold for

ratio of correct answer, which is used to determine whether the nth student can influence the discrimination of this test item;

if the student answers the test item correctly, then we increment Accumulator by the correct rate of the student; if the student answers the test item incorrectly, we

increment Accumulator by the incorrect rate of the student;

obtain the final discrimination by dividing the Accumulator by n.

The method for automation of dynamic test item collection and assessment, when compared with other prior arts, has the following advantages:

1. The method provided by the present invention can have test item contribution from students by DIY without limitations in space and time. Thus the test base would grow at a fast speed. The advantages due to the possibility of making test items by students are:

a) Fast growth of test base:

The resource of the test base would rapidly grow due to the join of students, and making test items is not the job of one teacher any more.

b) Variety in test items:

Test items made by teachers are from the viewpoint of the teachers. They are hard to match the need of all students. If the students can join the design of test items, then not only is the need matched, the teacher can also understand the students' levels and ideas thereby.

c) Creative learning:

The formation of a good test item needs a thorough understanding of the history of the test item itself. Once the test item is fully understood, it is then easy to vary the test item at one's will. In the process of making test items, the students can design them on one hand and have thoughts about the course content on the other. This naturally increases the learning effects and trains the creativity for the students.

However, DIY has to take into account the independence of the students, which has fewer problems in the college but might have some resistance in the high school.

2. The present invention allows the sharing of test items in several servers managed by different institutes. This multi-server structure similar to the distributive system does not speed up the speed of test item collection, but also facilitates communication and comparison among different test groups. For example, suppose two junior senior high schools share their test bases, then teachers can compare their test item styles and difficulty and students can benefit from this so as to be exposed to various test items. This method can thus enhance the test effect and the objectivity of the test base. This kind of advantages is indeed invaluable.

3. The present invention has the DIY function, and the test item discrimination is an indispensable feature. There are two kinds of test bases in DIYExamer, namely, the main test base and the temp test base. The former is the qualified test base, while the later is the test base that contains DIY test items to be assessed. (Test items designed by teachers can be put in either the main or the temp test base optionally.) For a test profile, the teacher can choose the ratio of number of test items from the main and the temp test bases so as to assess test items in both test bases. The DIYExamer server would perform calculations on the difficulty assessment of the test items in each randomly generated test. Through certain test filtering, the test items in the temp test base can be upgraded to the main test base. On the other hand, the test items in the main test base are not necessarily the best and can be improper after a period of time. Through the assessment procedure, test items in the main test base can be downgraded to the temp test base or even deleted from the system.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A method for automation of dynamic test item collection and assessment, which method allows a subject teacher and students to participate in making and contribute test items to a test base, wherein test items yet discriminated are stored at a temporary place in the test base, and are stored into the main test base after passing a discrimination assessment or are deleted if failing the discrimination assessment; and the test items already in the main test base are downgraded to be stored at the temporary place in the test base or even deleted if they can not pass subsequent discrimination assessments.

2. The method for automation of dynamic test item assessment of claim 1, wherein the discrimination is calculated as follows: suppose for a test item, Accumulator is the total discrimination number and n-1 students have worked on it. Now the nth student works on this test item. Then the method for determining the discrimination of the test item comprises the following steps:
verify if the score of the student is above the high threshold for ratio of correct answer (ranging from 73% to 100% in scores) or below the low threshold for ratio of correct answer (ranging from 0% to 27% in scores). If it does, then the score is influential in determining the discrimination of the test item;
if the score is higher (lower) than the highest (lowest) score among the past test takers, recalculate the new highest (lowest) score, and then the new high (low) threshold for ratio of correct answer, which is used to determine whether the nth student can influence the discrimination of this test item;
if the student answers the test item correctly, then we increment Accumulator by the correct rate of the student; if the student answers the test item incorrectly, we increment Accumulator by the incorrect rate of the student;
obtain the final discrimination by dividing the Accumulator by n.
